(19) United States
(12) Patent Application Publication
(10) Pub. No.: US 2015/0153607 A1
(43) Pub. Date: Jun. 4, 2015

(54) LCD DEVICE

(71) Applicant: Shenzhen China Star Optoelectronics Technology Co. Ltd., Shenzhen (CN)

(72) Inventors: Shih Hsiang Chen, Shenzhen (CN); Gang Yu, Shenzhen (CN); Ruilian Yang, Shenzhen (CN)

(21) Appl. No.: 13/703,364

(22) PCT Filed: Aug. 27, 2012
(86) PCT No.: PCT/CN12/80605

§ 371 Date: Dec. 11, 2012

(30) Foreign Application Priority Data
Aug. 21, 2012 (CN) 201210299002.6

(51) Int. Cl. G02F 1/1345; F21V 8/00; G02F 1/1335; G02F 1/1333

(52) U.S. Cl. CPC G02F 1/13452; G02F 1/133305; G02B 6/0088; G02F 1/1336

(57) ABSTRACT

The present invention discloses a liquid crystal display (LCD) device, which includes a display panel, a back light module, a flexible printed circuit board, and a chip. The back light module includes a back cover. The back cover has a protrusion facing the display panel, and the back cover has a recess corresponding to the protrusion on a bottom surface of the back cover. The flexible printed circuit board is electrically coupled to one side of the display panel, and bent to the bottom surface of the back cover. The chip is fixed on the flexible printed circuit board and located at the recess of the back cover, so that the chip is positioned away from the light source located beside the light guide plate, thereby overcoming an overheating problem of the chip in a narrow bezel LCD.

### FIELD OF THE INVENTION

The present invention relates to a display device, and especially to a liquid crystal display (LCD) device for achieving a demand of a narrow bezel.

### BACKGROUND OF THE INVENTION

Conventional thin film transistor liquid crystal display (TFT-LCD) includes an LC panel, a driver module, and a backlight module. The driver module is utilized to drive the LC panel to display frames. Referring to FIG. 1, FIG. 1 is a schematic drawing illustrating an LC panel without a gate printed circuit board (gate PCB) in the prior art. The LC panel 100 is coupled to a plurality of data chip on flex (COF) carrier tapes 120 and a plurality of gate COF carrier tapes 140. The data COF carrier tapes 120 are coupled to a data PCB 150, and the data COF carrier tapes 120 have data driver chips 125 thereon. The gate COF carrier tapes 140 have gate drivers 145 thereon.

Referring to FIG. 2, FIG. 2 is a partial cross-sectional view illustrating a narrow bezel LCD in the prior art. The backlight module includes a metal back cover 11, a mold frame 12, a light guide plate 13, a reflector 14, an optical film group 15, a light source 16, and so on. The light guide plate 13 and the reflector 14 are disposed in the metal back cover 11. The light source 16 is disposed on the metal back cover 11 and located beside the light guide plate 13. The optical film group 15 is laminated and disposed above the light guide plate 13; the LC panel 100 is disposed on the mold frame 12. The front bezel 17 is disposed on sides of the mold frame 12, and utilized to hold the LC panel 100 with the mold frame 12, so as to protect the LC panel 100.

Due to a tendency for a narrow bezel LCD, the gate COF carrier tapes 140 are usually bent to a side of the backlight module for reducing a width of the front bezel 17 which is above the LC panel 100. However, because of this design for the narrow bezel, the gate driver 145 is very close to the light source 16. The gate driver 145 may have an overheating problem stemming from the heat of the light source 16, causing product reliability decreases.

### SUMMARY OF THE INVENTION

An objective of the present invention is to provide an LCD device which can solve overheating problem stemming from that the gate driver is too close to the light source in the conventional narrow bezel technology, thereby realizing a narrow bezel LCD device with high reliability.

To achieve the foregoing objective, the present invention provides an LCD device, which includes a display panel, a back light module, a flexible printed circuit board, and a chip. The back light module includes a back cover. The back cover has a protrusion facing the display panel, and the back cover has a recess corresponding to the protrusion on a bottom surface of the back cover. The flexible printed circuit board is electrically coupled to one side of the display panel, and bent to the bottom surface of the back cover. The chip is fixed on the flexible printed circuit board and located at the recess of the back cover.

In the LCD device of the preferred embodiment, the back light module further comprises a reflector and a light guide plate disposed on the back cover. The protrusion is utilized to push against the reflector so that the reflector abuts against the light guide plate. In addition, the back light module further comprises a light source positioned beside the light guide plate. The back cover further has a side wall perpendicular to the display panel, and the light source is fixed on the side wall. Preferably, the protrusion is trapezoidal. Preferably, the flexible printed circuit board abuts against the bottom surface of the back cover.

In the LCD device of the preferred embodiment, the flexible printed circuit board is a COF carrier tape. Preferably, the COF carrier tape is a gate COF carrier tape, and the chip is a gate driver.

In the LCD device of the preferred embodiment, the recess of the back cover is a striped recess parallel to the side of the display panel. Preferably, the back cover is a metal back cover which is made by stamping.

In comparison with the prior art, there is the recess disposed on the back cover; thus, the COF carrier tape can be bent around to the recess on the bottom surface of the back cover, so that the chip is positioned away from the light source located beside the light guide plate, thereby overcoming the overheating problem of the chip. Moreover, the protrusion of said back cover also has a function for making the reflector abut against the light guide plate; therefore, a thickness of the backlight module can be decreased.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a schematic drawing illustrating an LC panel without a printed circuit board in the prior art;

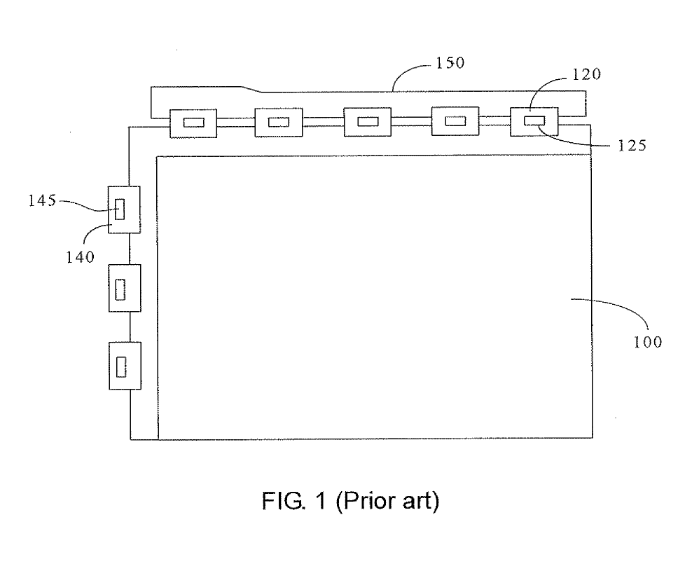

FIG. 2 is a partial cross-sectional view illustrating a narrow bezel LCD in the prior art;

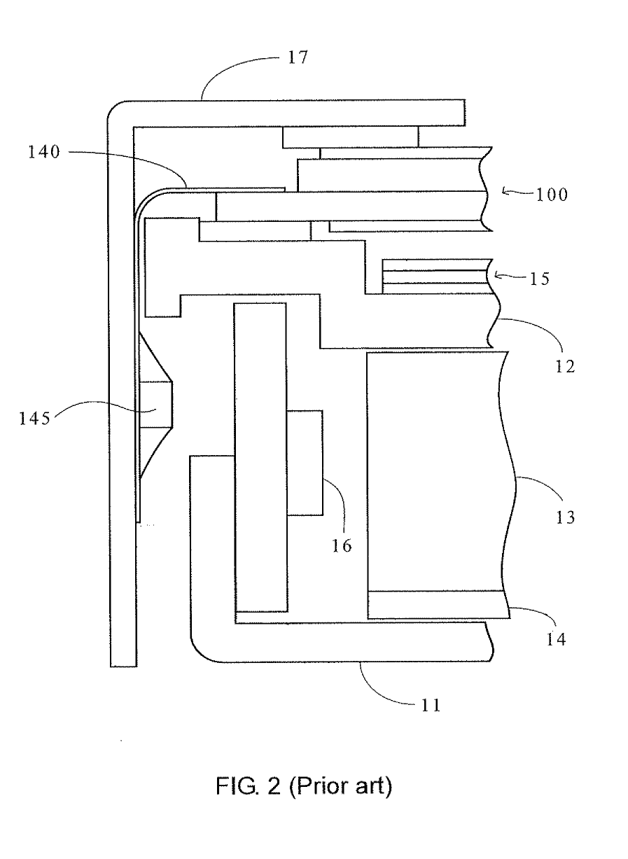

FIG. 3 is a partial sectional view illustrating an LCD device according to one preferred embodiment of the present invention; and

FIG. 4 is a schematic drawing illustrating a bottom surface of the back cover according to one preferred embodiment of the present invention.

### DETAILED DESCRIPTION OF THE PREFERRED EMBODIMENTS

Descriptions of the following embodiments refer to attached drawings which are utilized to exemplify specific embodiments. In different drawings, the same reference numbers will be used throughout the drawings to refer to the same or like parts.

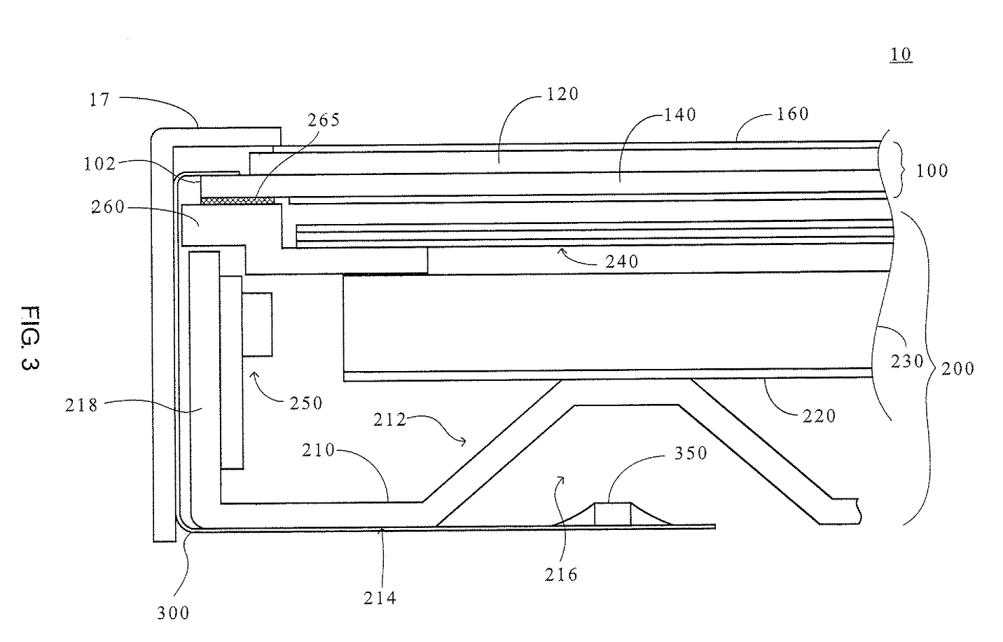

Referring to FIG. 3, FIG. 3 is a partial sectional view illustrating an LCD device according to one preferred embodiment of the present invention. The LCD device 10 of the preferred embodiment mainly includes a display panel 100, a back light module 200, a flexible printed circuit board 300, a chip 350, and a front bezel 17.

In the embodiment, the display panel 100 includes an upper substrate 120, a lower substrate 140, and a liquid crystal layer (not shown) between the upper and lower substrates. It is worth mentioning that a polarizer 160 is disposed respectively on outer surfaces of the upper substrate 120 and the lower substrate 140.

As shown in FIG. 3, the back light module 200 mainly includes a back cover 210, a reflector 220, a light guide plate 230, an optical film group 240, a light source 250, and a mold frame 260. The back cover 210 has a protrusion 212 facing the display panel 110, and the back cover 210 has a recess 216 corresponding to the protrusion 212 on a bottom surface 214 of the back cover 210. In the embodiment, the protrusion 212 is trapezoidal. However, in other embodiments, the protrusion 212 can also be implemented to be other shapes, e.g. semicircle, rectangle, triangle, and so on.

The reflector 220 and the light guide plate 230 are disposed on the back cover 210. The protrusion 210 is utilized to push against the reflector 220 so that the reflector 220 abuts against the light guide plate 230. It can be seen from the foregoing that the reflector 220 is stuck on the light guide plate 230 without glue; thus, the reflector 220 can be tightly close to the light guide plate 230 for reducing light loss. Furthermore, there is no thickness of the glue between the reflector 220 and light guide plate 230, so a thickness of the back light module 200 can be reduced.

As shown in FIG. 3, the back light module 200 further has a light source 250 positioned beside the light guide plate 230. Preferably, the light source 250 is a light-emitting diode. The back cover 210 further has a side wall 218 perpendicular to the display panel 100, and the light source 250 is fixed on the side wall 218.

The optical film group 240 is laminated and disposed above the light guide plate 230; the LC panel 100 is disposed on the mold frame 260. There is a buffering pad 265 disposed between the LC panel 100 and the mold frame 260 for reducing shocks to the LC panel 100 form the outside. The front bezel 17 is disposed on sides of the mold frame 260, and utilized to hold the LC panel 100 with the mold frame 260, so as to protect the LC panel 100.

One end of the flexible printed circuit board 300 is electrically coupled to one side 102 of the display panel 100, and bent to the bottom surface 214 of the back cover 210. Preferably, the flexible printed circuit board 300 abuts against the bottom surface 214 of the back cover 210. The chip 350 is fixed on the flexible printed circuit board 300 and located at the recess 216 of the back cover 210. In the LCD device 10 of the preferred embodiment, the flexible printed circuit board 300 is a COF carrier tape. Preferably, the COF carrier tape is a gate COF carrier tape, and the chip 350 is a gate driver. However, in other embodiments, the COF carrier tape is a source COF carrier tape, and the chip 350 is a source driver.

It is worth mentioning that the chip 350 is disposed on an opposite surface of the COF carrier tape in comparison with the prior art, so that the chip 350 is disposed toward the recess 216, i.e. received within the recess 216, when the COF carrier tape is bent to the recess 216 of the back cover 210.

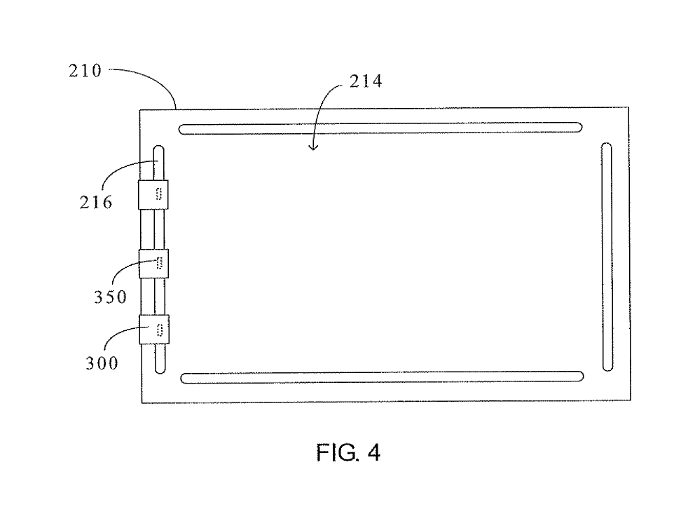

Referring to FIG. 4, FIG. 4 is a schematic drawing illustrating a bottom surface of the back cover according to one preferred embodiment of the present invention. In the LCD device 10 of the preferred embodiment, the recess 216 of the back cover 210 is a striped recess that is parallel to the side 102 of the display panel 100. Preferably, the striped recess is set to correspond with the four sides of display panel 100 for fixing the reflector 220. In the embodiment, the flexible printed circuit board 300 is three gate COF carrier tapes; the chip 350 is three corresponding gate drivers. The gate COF carrier tapes are bent to the bottom surface 214 of the back cover 210, so that the gate drivers are received in the striped recess. In another embodiment, the flexible printed circuit board 300 can be a plurality of source COF carrier tapes; the chip 350 is a plurality of corresponding source drivers. The source COF carrier tapes are bent to the bottom surface 214 of the back cover 210, so that the source drivers are received in the striped recess.

It is worth mentioning that the back cover 210 is a metal back cover, and the protrusion 212/recess 216 is made by stamping. However, materials of the back cover 210 are not limited in the present invention.

In summary, there is the recess 216 disposed on the back cover 210 of the present invention; thus, the COF carrier tape can be bent around to the recess 216 on the bottom surface 214 of the back cover 210, so that the chip 350 is positioned away from the light source 250 located beside the light guide plate 230, thereby overcoming the overheating problem of the chip in the conventional narrow bezel technology. Moreover, the protrusion 212 of said back cover 210 also has a function for making the reflector 220 abut against the light guide plate 230; therefore, a thickness of the backlight module 200 can be decreased.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A liquid crystal display (LCD) device, comprising:
a display panel;
a back light module comprising a back cover, the back cover having a protrusion facing the display panel, and the back cover having a recess corresponding to the protrusion on a bottom surface of the back Cover;
a COF carrier tape electrically coupled to one side of the display panel, and bent to the bottom surface of the back cover and abutting against the bottom surface; and
a chip fixed on the COF carrier tape and located at the recess of the back cover.

2. The LCD device according to claim 1, wherein the back light module further comprises a reflector and a light guide plate disposed on the back cover; the protrusion is utilized to push against the reflector so that the reflector abuts against the light guide plate.

3. The LCD device according to claim 2, wherein the back light module further comprises a light source positioned beside the light guide plate.

4. The LCD device according to claim 3, wherein the back cover further has a side wall perpendicular to the display panel, and the light source is fixed on the side wall.

5. The LCD device according to claim 1, wherein the protrusion is trapezoidal.

6. The LCD device according to claim 1, wherein the COF carrier tape is a gate COF carrier tape, and the chip is a gate driver.

7. The LCD device according to claim 1, wherein the recess of the back cover is a striped recess parallel to the side of the display panel.

8. The LCD device according to claim 1, wherein the back cover is a metal back cover which is made by stamping.

9. An LCD device, comprising:
a display panel;
a back light module comprising a back cover, the back cover having a protrusion facing the display panel, and the back cover having a recess corresponding to the protrusion on a bottom surface of the back cover;
a flexible printed circuit board electrically coupled to one side of the display panel, and bent to the bottom surface of the back cover; and
a chip fixed on the flexible printed circuit board and located at the recess of the back cover.

10. The LCD device according to claim 9, wherein the back light module further comprises a reflector and a light guide plate disposed on the back cover; the protrusion is utilized to push against the reflector so that the reflector abuts against the light guide plate.

11. The LCD device according to claim 10, wherein the back light module further comprises a light source positioned beside the light guide plate.

12. The LCD device according to claim 11, wherein the back cover further has a side wall perpendicular to the display panel, and the light source is fixed on the side wall.

13. The LCD device according to claim 9, wherein the protrusion is trapezoidal.

14. The LCD device according to claim 9, wherein the flexible printed circuit board abuts against the bottom surface of the back cover.

15. The LCD device according to claim 9, wherein the flexible printed circuit board is a COF carrier tape.

16. The LCD device according to claim 15, the COF carrier tape is a gate COF carrier tape, and the chip is a gate driver.

17. The LCD device according to claim 9, wherein the recess of the back cover is a striped recess parallel to the side of the display panel.

18. The LCD device according to claim 9, wherein the back cover is a metal back cover which is made by stamping.
